(19) United States
(12) Patent Application Publication
(10) Pub. No.: US 2026/0321693 A1
(43) Pub. Date: Oct. 15, 2026

(54) Acid Mine Drainage Fuel Cell (AMD-FC) Simultaneous Electricity Generation System and Method

(71) Applicant: Chinese Research Academy of Environmental Sciences, Beijing (CN)

(72) Inventors: Jinyuan JIANG, Beijing (CN); Yue ZHANG, Beijing (CN); Dongni SHI, Beijing (CN); Wei TAN, Beijing (CN); Haoyang SONG, Beijing (CN)

(21) Appl. No.: 18/847,214

(22) PCT Filed: Apr. 30, 2024
(86) PCT No.: PCT/CN2024/090747

§ 371 Date: Sep. 13, 2024

(30) Foreign Application Priority Data
Nov. 10, 2023 (CN) 202311492912.0

(51) Int. Cl. H01M 8/08; H01M 8/06

(52) U.S. Cl. CPC H01M 8/08; H01M 8/06

(57) ABSTRACT

The present application discloses an acid mine drainage fuel cell simultaneous electricity generation system, including a cell structure, where the cell structure is composed of an anode chamber, a cathode chamber, an anode electrode, a cathode electrode, a proton exchange membrane, and an external wire; the proton exchange membrane is provided between the cathode chamber and the anode chamber; an anode is provided at one end of the anode chamber away from the cathode chamber, and a cathode is provided at one end of the cathode chamber away from the anode chamber; the anode is connected to the cathode by the wire outside the anode chamber and the cathode chamber. The solutions of the present application use the acid mine drainage to generate electricity, achieving energy utilization of the mine drainage, and simultaneously, treat the acid mine drainage containing iron to recover iron ions.

The present application claims priority to Chinese Patent Application No. CN2023114929120, filed on Nov. 10, 2023 and entitled “Acid Mine Drainage Fuel Cell (AMD-FC) Simultaneous Electricity Generation System and Method”. The entire content of the above application is hereby incorporated by reference as a whole.

### TECHNICAL FIELD

The present application relates to the field of acid mine drainage energization technologies, and in particular, to an acid mine drainage fuel cell simultaneous electricity generation system and a method.

### BACKGROUND OF THE INVENTION

The description of background in the present application belongs to relevant technology related to the present application, which is only used to illustrate and facilitate the understanding of invention content of the present application. It should not be understood that the applicant explicitly believes or presumes that it is the prior art of the present application on the date of the first application.

The mining industry is crucial for the economy of both developed and developing countries. However, water is one of natural resources severely affected by this important industry. Acid mine drainage generated by mining is considered one of the most catastrophic ecological problems and a challenging environmental problem worldwide. The acid mine drainage has characteristics of low pH (generally between 2.3 and 5.7), high SO₄²⁻, and containing Fe²⁺, Fe³⁺, Mn²⁺, and other metal ions. The study has shown that the total iron content in the acid mine drainage is generally between 300-800 mg/L, and the total iron content in some mine drainage even exceeds 1 g/L. In the acid mine drainage, as the pH decreases, the dissolution process of minerals is accelerated, resulting in an increase in the iron content. This type of mine drainage has strong acidity, high mineralization, and high hardness, such that it easily corrodes the underground mining equipment. When this type of mine drainage is extracted and used, it is easy to form iron scale in the pipeline, increasing the cost of subsequent cleaning work and threatening the safety production. Random discharge can also damage the water environment of rivers. The high iron content in the acid mine drainage seriously threatens the safety of surrounding groundwater. When the groundwater replenishes the surface water, it can lead to an increase in the iron content in the surface water, threatening the survival of aquatic organisms in rivers and lakes. After this type of mine drainage enters the river, the suspension and aggregation of inorganic particles will cause a decrease in the transparency of rivers. Related studies have shown that when the acid mine drainage containing iron enters the water, neutralization and precipitation occur, and sediment is suspended in the form of extremely small particles in the water, resulting in a decrease in the transparency of water and a color change into yellow, which is not conducive to the reprocessing and resource utilization of the acid mine drainage. Therefore, removing iron ions from the acid mine drainage containing iron can not only save the operation cost of treatment process, but also alleviate the burden on groundwater environment to a certain extent, achieving the recycle of water resources and sustainable economic development.

The purpose of treating the acid mine drainage is to increase the pH of water and achieve the controllable removal of iron and other metals. At present, the general method for treating the acid mine drainage is limestone neutralization, but this method is easy to cause secondary pollution. In recent years, with the improvement of emission standards and reuse requirements, problems of conventional processes in terms of treatment effect, investment, and operation cost have become increasingly prominent, and there is a strong demand for new technologies.

Chinese patent CN218879648U discloses an iron-containing acid mine drainage treatment system, which belongs to the field of mine drainage treatment equipment technologies, solving the problem of poor treatment effect of iron containing acid drainage in the prior art. The present utility model includes a mixed reaction tank, an inclined tube sedimentation tank, a filter membrane tank, and a dosing apparatus connected to the mixed reaction tank that are connected in sequence. The inclined tube sedimentation tank is divided from top to bottom into a water cleaning area, a separation area, a water distribution area, a sludge concentration area, and a sedimentation area. An isolation plate is provided in the separation area, and multiple separation channels are inclined on the isolation plate. The mixed reaction tank is configured to remove iron ions and ferrous ions from the iron-containing acid mine drainage to be treated, to acquire mixture of iron ion precipitates. The inclined tube sedimentation tank is configured to separate the iron ion precipitates in the mixture, to acquire 1 stage produced water. The filter membrane tank is configured to filter the 1 stage produced water to acquire 2 stage produced water. The present utility model acquires 2 stage produced water with the iron content less than 0.3 mg/L, achieving efficient iron removal.

Chinese patent CN114014462A discloses a low-cost treatment method for metal ion resource recovery in acid mine drainage, including the following steps: Step 1, purification of acid mine drainage: the acid mine drainage is extracted into a purification equipment for purification, during the purification, a large amount of metal ions such as Al, Fe, Mg, and Mn contained in the acid mine drainage are selectively removed through step-by-step precipitation, acquiring high-purity precipitates that can be used as resources. The present application selectively removes different metal precipitates to acquire high-purity precipitates that can be used as resources, greatly reducing the amount of solid waste formed during the treatment of acid mine drainage, and even achieving an operation mode without solid waste. It can greatly reduce the cost of solid waste reprocessing and the total operation cost of acid mine drainage purification. The overall purification demand can selectively recycle all or part of metal precipitates as resources based on water quality and the value of precipitate resources.

Chinese patent CN113754113A discloses a system for reducing a continuous alkali production system for treating low pH, high iron, and high sulfate mine drainage, including a reaction channel. The reaction channel is sequentially provided with a limestone layer and an organic matter layer from bottom to top, and a water layer is provided at the top of the organic matter layer. The limestone layer is connected to a sedimentation tank through an outlet pipe, and one end of the outlet pipe extending from the reaction channel is provided with a spray valve to allow the drainage reacted by the organic matter layer and limestone layer to enter the sedimentation tank by means of spraying. The system of the present application is suitable for the treatment of low pH, high iron, and high sulfate mine drainage. The consumption of dissolved oxygen by the organic matter layer in the reaction channel reduces the water redox potential, resulting in the reduction and removal of sulfate ions. Subsequently, the dissolution of limestone increased the pH of water, resulting in the precipitation and removal of heavy metals such as iron, aluminum, and copper. The effluent drainage is discharged through the corrosion-resistant perforated pipe at the bottom of the reaction channel, and then discharged into the sedimentation tank by spraying to further remove trivalent iron ions.

The technology disclosed in Chinese patent CN218879648U is a neutralization and filtration method for treating acid mine drainage containing iron. The technology disclosed in Chinese patent CN114014462A is a stepwise precipitation method for treating acid mine drainage. The technology disclosed in Chinese patent CN113754113A is a limestone neutralization and microbial oxidation-reduction method for treating acid mine drainage, and continuous dosing is required, resulting in secondary pollution and additional treatment costs. The drawbacks of the prior art are that they are energy consuming, require the addition of other agents (such as limestone), and produce secondary pollution. At present, there is a lack of acid drainage treatment technologies that do not add agents, have low energy consumption or even production capacity, and do not produce secondary pollution. Therefore, the present application provides an acid mine drainage fuel cell simultaneous electricity generation system.

### SUMMARY

The purpose of embodiments of the present application is to provide an acid mine drainage fuel cell (AMD-FC) simultaneous electricity generation system and a method.

An acid mine drainage fuel cell (AMD-FC) simultaneous electricity generation system, including a cell structure, where the cell structure is composed of an anode chamber, a cathode chamber, an anode electrode, a cathode electrode, a proton exchange membrane, and an external wire; the proton exchange membrane is provided between the cathode chamber and the anode chamber; an anode is provided at one end of the anode chamber away from the cathode chamber, and a cathode is provided at one end of the cathode chamber away from the anode chamber; the anode is connected to the cathode by the wire outside the anode chamber and the cathode chamber; the anode chamber contains anode electrolytic solution, and the anode electrolytic solution contains ferrous sulfate; the cathode chamber contains cathode electrolytic solution; the anode chamber is provided with an anode outlet and an anode inlet; the anode inlet is connected to an anode inlet sink, and the anode inlet sink contains acid mine drainage that removes dissolved oxygen; the anode outlet is connected to an anode outlet sink; the cathode chamber is provided with a cathode inlet and a cathode outlet, the cathode inlet and the cathode outlet are connected to a cathode electrolytic solution supply apparatus, and the cathode chamber is further provided with an oxygen vent.

Further, the cell structure is a dual chamber air fuel cell system, a single chamber air cathode fuel cell, an H-type dual chamber fuel cell, an upflow fuel cell, or a cylindrical fuel cell.

Further, the anode chamber contains the anode electrolytic solution, and the anode electrolytic solution is the acid mine drainage: [Mn²⁺]=0-30 mg/L, [Fe²⁺]=100-2000 mg/L, [Zn²⁺]=0-80 mg/L, [SO₄²⁻]=300-2000 mg/L, [Na⁺]=3.22-6.9 g/L, [HCO₃⁻]=2.44-6.1 g/L, [Cl⁻]=3.55-7.1 g/L, pH=2-6; and the cathode chamber contains the cathode electrolytic solution: [Na⁺]=3.22-6.9 g/L, [HCO₃⁻]=2.44-6.1 g/L, [Cl⁻]=3.55-7.1 g/L, and H₂SO₄ for pH adjustment.

Further, the acid mine drainage is continuously inputted into the anode chamber, and the acid mine drainage fuel cell simultaneous electricity generation system can continuously and stably operate.

Further, the anode inlet of the anode chamber is connected to the anode inlet sink, and the anode inlet sink contains the acid mine drainage; the anode inlet sink is connected to an air bottle, and the air bottle is configured for accommodating CO₂ or N₂ to remove dissolved oxygen in the drainage; and the cathode inlet of the cathode chamber and the cathode outlet of the cathode chamber are respectively connected to the cathode electrolytic solution supply apparatus.

Further, the anode outlet of the anode chamber is connected to the anode outlet sink, the anode outlet sink filters the reacted acid mine drainage as cathode electrolytic solution for starting a reactor next time, the pH of the acid mine drainage is increased in the cathode chamber, and new acid mine drainage is injected into the anode to remove Fe ions.

Further, the anode is a carbon cloth and the cathode is a carbon cloth loading Pt.

Further, the cathode chamber can use an air cathode, one side of a cathode electrode loading platinum catalyst faces solution and the other side contacts with air, directly using O₂ in the air, or blowing O₂ into the cathode electrolytic solution using an air supply system.

Further, a resistor is provided at the wire connecting the anode to the cathode, a digital multimeter is connected in parallel at the resistor, and the digital multimeter is connected to a computer.

An acid mine drainage fuel cell simultaneous electricity generation method, where it is completed using the system above, and includes the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

The embodiments of the present application have the following beneficial effects.

In the present application, the anode chamber contains the acid mine drainage, and divalent iron in AMD is oxidized to trivalent iron, releasing electrons and forming a precipitate to remove iron from the drainage. In the cathode chamber, protons react with oxygen to generate water and consume electrons. Protons travel from the anode chamber to the cathode chamber through the proton exchange membrane, and most electrons generated in the anode chamber pass through the anode via the external circuit to the cathode to participate in the reaction, thereby forming the current. The solution of the present application is green and free from secondary pollution, achieving the resource utilization of acid mine drainage. The precipitate generated in the anode chamber can be used as the pigment to achieve iron ion recovery. The solution can also be used for the simultaneous electricity generation when treating the acid mine drainage containing iron.

### BRIEF DESCRIPTION OF THE DRAWINGS

FIG. 1 is a continuous reaction flow diagram of an acid mine drainage fuel cell (AMD-FC) simultaneous electricity generation system according to the embodiments of the present application. A CO₂ bottle 9 is used to continuously aerate an anode inlet sink 7 to remove dissolved oxygen in acid mine drainage. A peristaltic pump is used to inject the acid mine drainage into an anode chamber 3, and inject cathode electrolytic solution 10 into a cathode chamber 4. In the anode chamber 3, Fe²⁺ in the acid mine drainage loses electrons and is converted into Fe³⁺, which combines with OH⁻ to form a precipitate and remove Fe ions. The generated H⁺ is transferred from the anode chamber 3 to the cathode chamber 4 through a proton exchange membrane, and reacts with O₂ at a cathode electrode 2. The electrons generated in the anode chamber travel from an anode electrode 1 to a cathode 2 through an external circuit, thereby forming the current. The acid mine drainage after reaction in the anode chamber enters an anode outlet sink 8, and the cathode electrolytic solution circulates. A digital voltmeter 12 is connected to a computer 13 to continuously detect the output voltage.

FIG. 2 is a configuration diagram of a H-type dual chamber fuel cell according to the embodiments of the present application.

FIG. 3 is a configuration diagram of a single chamber air cathode fuel cell according to the embodiments of the present application.

FIG. 4 is a configuration diagram of a cylindrical fuel cell according to the embodiments of the present application.

FIG. 5 is a configuration diagram of an upflow fuel cell according to the embodiments of the present application.

FIG. 6 is a voltage variation curve diagram using Fe²⁺ in AMD for electricity generation according to the embodiments of the present application. It can be seen from the figure that Fe²⁺ ions in AMD are used for the electricity generation, and the open circuit voltage is 641 mV. After connecting a 1000Ω external load resistor, the voltage immediately decreases to 496 mV, and then gradually decreases to 0 m V within the next 24 hours, mainly due to the gradual oxidation of Fe²⁺ ions.

FIG. 7 is a diagram of precipitates collected in an anode chamber, and it can be seen that the color of precipitates generated in the anode chamber is mainly yellow brown.

FIG. 8 is an X-ray diffraction pattern acquired by characterizing anode precipitates. Compared with the standard pattern, it can be seen that the main component in the sediment is FeOOH, and the generated goethite (FeOOH) can be used for iron-smelting or recycling as pigments.

FIG. 9 is a SEM pattern acquired by characterizing anode precipitates, whose crystal shape is mainly needle shaped.

FIG. 10 is a continuous operation voltage curve diagram of AMD-FC. A peristaltic pump is used to continuously inject acid mine drainage into an anode chamber, and fresh water samples are added to an inlet sink occasionally. When a cell starts operating, the output voltage is low with small fluctuations. When the first batch of samples is added, the voltage increases to around 70 m V, and then decreases to around 40 m V. After the second batch of samples is added, the voltage once again increases to around 70 m V, and then decreases to around 45 m V for stable operation. Afterwards, for each batch of samples is added, the voltage increases to around 90 mV, and then decreases to around 50 mV for stable operation.

### DETAILED DESCRIPTION

The present application is described below in some embodiments of the present invention in conjunction with embodiments.

In order to better illustrate the embodiments of the present application or the technical solutions in the prior art, in the following description, “one embodiment” or “embodiment” in different contexts may not necessarily refer to the same embodiment. Different embodiments can be replaced or combined with each other, and for those ordinary skilled in the art, other implementation manners can be acquired based on these embodiments without creative labor.

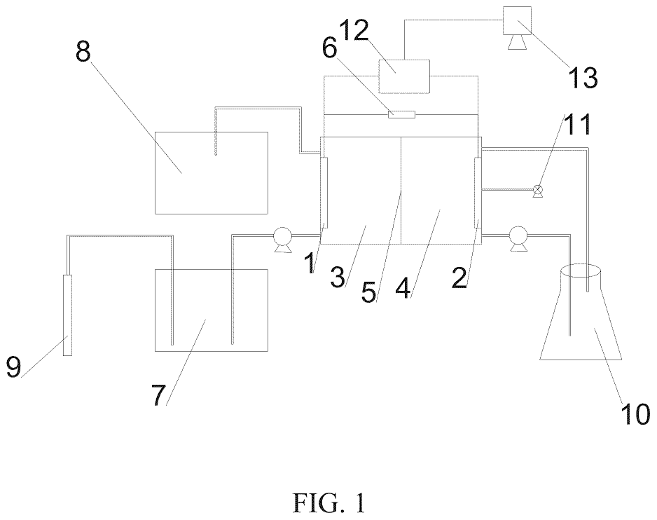

FIG. 1 is a continuous reaction flow diagram of an acid mine drainage fuel cell (AMD-FC) simultaneous electricity generation system according to the embodiments of the present application. In combination with FIG. 1, an acid mine drainage fuel cell simultaneous electricity generation system includes fuel supply systems 7, 8, 9, iron ion oxidation systems 1, 3, electron transmission systems 1, 6, 2, proton transfer systems 3, 4, 5, air supply systems 11, oxygen reduction reaction systems 2, 4, cathode electrolytic solution circulation systems 4, 10, and data acquisition systems 12, 13. A cell structure is composed of an anode chamber 3, a cathode chamber 4, an anode electrode 1, a cathode electrode 2, a proton exchange membrane 5, and an external wire; the proton exchange membrane 5 is provided between the cathode chamber 4 and the anode chamber 3; an anode 1 is provided at one end of the anode chamber 3 away from the cathode chamber 4, and a cathode 2 is provided at one end of the cathode chamber 4 away from the anode chamber 3; the anode 1 is connected to the cathode 2 by the wire outside the anode chamber 3 and the cathode chamber 4; the anode chamber 3 contains anode electrolytic solution, and the anode electrolytic solution contains ferrous sulfate; the cathode chamber 4 contains cathode electrolytic solution; the anode chamber 3 is provided with an anode outlet and an anode inlet; influent drainage of the anode inlet is acid mine drainage that removes dissolved oxygen; the cathode chamber is provided with a cathode inlet and a cathode outlet, the cathode inlet and the cathode outlet are connected to a cathode circulating electrolytic solution sink 10, and the cathode chamber 4 is further provided with an oxygen vent, which is connected to an oxygen supply apparatus 11.

In combination with FIG. 1, a CO₂ bottle 9 is used to continuously aerate an anode inlet sink 7 to remove dissolved oxygen in acid mine drainage. A peristaltic pump is used to inject the acid mine drainage into an anode chamber 3, and inject cathode electrolytic solution 10 into a cathode chamber 4. In the anode chamber 3, Fe²⁺ in the acid mine drainage loses electrons and is converted into Fe³⁺, which combines with OH⁻ to form a precipitate and remove Fe ions. The generated H⁺ is transferred from the anode chamber 3 to the cathode chamber 4 through a proton exchange membrane 5, and reacts with O₂ at a cathode electrode 2. The electrons generated in the anode chamber 3 travel from an anode electrode 1 to a cathode 2 through an external circuit, thereby forming the current. The acid mine drainage after reaction in the anode chamber 3 enters an anode outlet sink 8, and the cathode electrolytic solution circulates. A digital voltmeter 12 is connected to a computer 13 to continuously detect the output voltage.

In some embodiments of the present application, it is not limited to a dual chamber air fuel cell system used herein. A single chamber air cathode fuel cell, an H-type dual chamber fuel cell, an upflow fuel cell, a cylindrical fuel cell, and other fuel cells can all be used as a reactor of the present application.

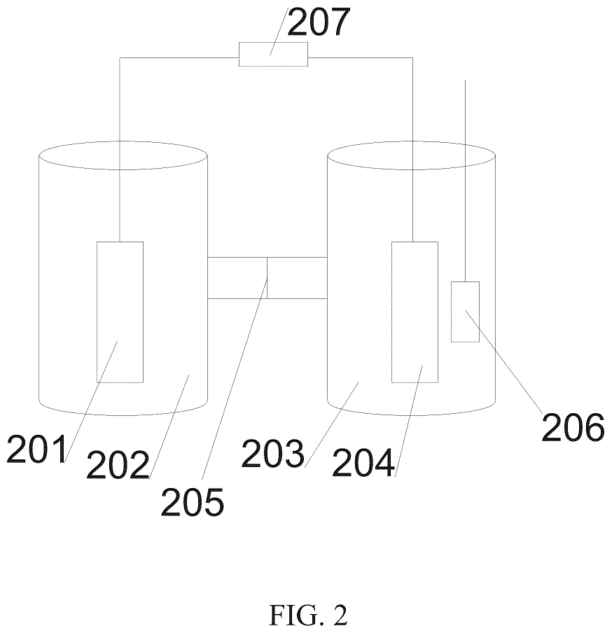

FIG. 2-FIG. 5 are configuration diagrams of AMD-FC reactors that can be adopted in the embodiments of the present application, it is not limited to a dual chamber air fuel cell system used herein. A single chamber air cathode fuel cell, an H-type dual chamber fuel cell, an upflow fuel cell, a cylindrical fuel cell, and other fuel cells can all be used as a reactor of the present application. The single chamber air cathode fuel cell only has one electrode chamber. Due to an anaerobic environment required for anodic reaction, the distance between an anode electrode and a cathode electrode is relatively close, and oxygen near the cathode electrode can penetrate into the vicinity of the anode, affecting the anodic reaction. The H-type fuel cell, upflow fuel cell, and cylindrical fuel cell all have two chambers, with the cathode electrode immersed in the electrolytic solution, requiring extra aeration, and dissolved oxygen concentration is low, resulting in a poor electricity generation effect. The dual chamber air cathode fuel cell used in the embodiments reasonably control the distance between two electrodes, and the cathode electrode is in direct contact with air, without the requirement for additional air supply and with low energy consumption.

FIG. 2 is a configuration diagram of a H-type dual chamber fuel cell according to the embodiments of the present application. In an anode chamber 202, Fe²⁺ loses electrons and is converted into Fe³⁺, which combines with OH⁻ to form a precipitate and is removed. The generated H⁺ in the anode chamber is transferred to a cathode chamber 203 through a proton exchange membrane 205, and reacts with oxygen provided by an oxygen supply apparatus 206 at a cathode electrode 204 to generate water. The electrons generated in the anode chamber 202 are transmitted from an anode electrode 1 to a cathode 204 through an external circuit of a load resistor 207, thereby forming the current.

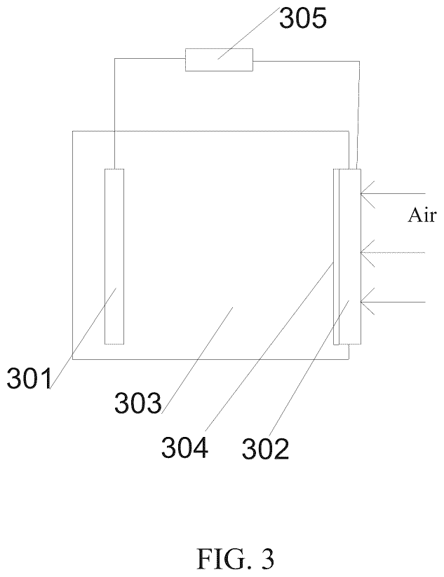

FIG. 3 is a configuration diagram of a single chamber air cathode fuel cell according to the embodiments of the present application. In an electrode chamber 303, Fe²⁺ in acid mine drainage participates in reaction, and a proton exchange membrane 304 and a cathode electrode 302 constitute a membrane electrode. In the electrode chamber 303, Fe²⁺ loses electrons and is converted into Fe³⁺, which combines with OH⁻ to form a precipitate and is removed. The generated H⁺ reacts with oxygen at the cathode electrode 302 through the proton exchange membrane 304 to generate water. The electrons generated are transmitted from an anode 301 to a cathode 302 through an external circuit of a load resistor 305, thereby forming the current.

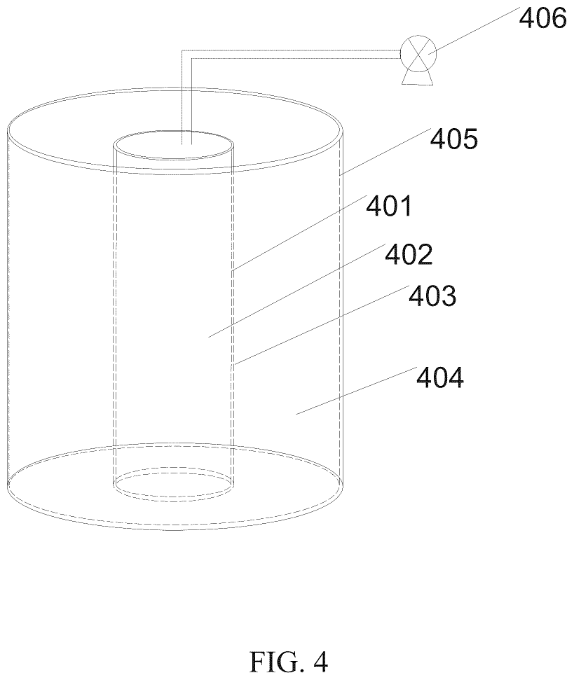

FIG. 4 is a configuration diagram of a cylindrical fuel cell according to the embodiments of the present application. The cylindrical fuel cell is composed of two concentric organic glass cylinders. There are uniformly provided circular holes on the circumference of inner cylinder, and a proton exchange membrane 403 wraps around the outer surface of inner cylinder. A cathode electrode 401 tightly covers the inner surface of inner cylinder, and an anode electrode 405 covers the inner surface of the outer cylinder. In an anode chamber 404, Fe²⁺ loses electrons and is converted into Fe³⁺, which combines with OH⁻ to form a precipitate and is removed. The H⁺ generated in the anode chamber 404 travels to a cathode chamber 402 through the proton exchange membrane 403, and reacts with oxygen provided by an oxygen supply apparatus 406 at the cathode electrode 401 to generate water. The electrons generated in the anode chamber 404 are transmitted from an anode electrode 405 to the cathode 401 through an external circuit, thereby forming the current.

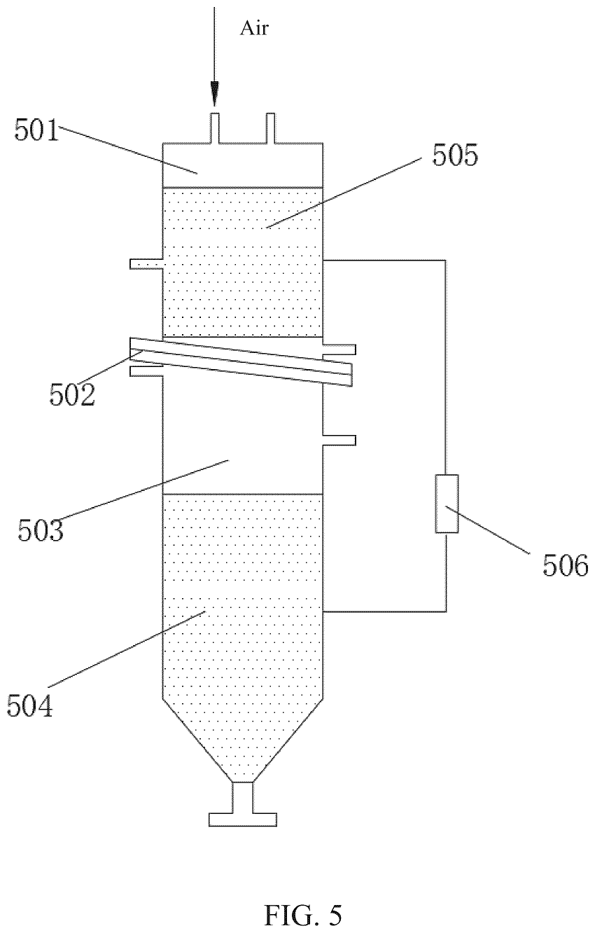

FIG. 5 is a configuration diagram of an upflow fuel cell according to the embodiments of the present application. The upflow fuel cell is composed of two cylindrical organic glass chambers. An anode chamber 503 is located below, and a cathode chamber 501 is located above the anode chamber, separated by a proton exchange membrane 502 in the middle, which forms a 15° angle with a horizontal plane to prevent the accumulation of bubbles. The material of a cathode electrode 505 and an anode 504 is reticulated vitreous carbon (RVC). In the anode chamber 503, Fe²⁺ loses electrons and is converted into Fe³⁺, which combines with OH⁻ to form a precipitate and is removed. The H⁺ generated in the anode chamber 503 travels to the cathode chamber 501 through the proton exchange membrane 502, and reacts with oxygen at the cathode 505 to generate water. The electrons generated in the anode chamber 503 are transmitted from the anode 504 to the cathode 505 through an external circuit of a load resistor 506, thereby forming the current.

In some embodiments of the present application, the anode chamber contains the anode electrolytic solution, and the anode electrolytic solution is the acid mine drainage: [Mn²⁺]=0-30 mg/L, [Fe²⁺]=100-2000 mg/L, [Zn²⁺]=0-80 mg/L, [SO₄²⁻]=300-2000 mg/L, [Na⁺]=3.22-6.9 g/L, [HCO₃⁻]=2.44-6.1 g/L, [Cl⁻]=3.55-7.1 g/L, pH=2-6; and the cathode chamber contains the cathode electrolytic solution: [Na⁺]=3.22-6.9 g/L, [HCO₃⁻]=2.44-6.1 g/L, [Cl⁻]=3.55-7.1 g/L, and H₂SO₄ for pH adjustment.

In some embodiments of the present application, the acid mine drainage is continuously inputted into the anode chamber, and the acid mine drainage fuel cell simultaneous electricity generation system can continuously and stably operate.

In some embodiments of the present application, as shown in FIG. 1, the anode inlet of the anode chamber 3 is connected to the anode inlet sink 7, and the anode inlet sink 7 contains the acid mine drainage. The anode inlet sink 7 is connected to an air bottle 9, and the air bottle 9 is configured for accommodate CO₂ or N₂ to remove dissolved oxygen in the drainage. The cathode inlet of the cathode chamber and the cathode outlet of the cathode chamber are respectively connected to the cathode electrolytic solution supply apparatus 10.

In some embodiments of the present application, the anode outlet of the anode chamber outlet is connected to the anode outlet sink 8, the anode outlet sink 8 filters the reacted acid mine drainage as cathode electrolytic solution for starting a reactor next time, the pH is increased in the cathode chamber, and new acid mine drainage is injected into the anode to remove Fe ions.

In some embodiments of the present application, the anode 1 is a carbon cloth, and the cathode 2 is a carbon cloth loading Pt.

In some embodiments of the present application, the cathode chamber 4 can use an air cathode, one side of a cathode loading Pt catalyst faces solution and the other side contact with air, directly using O₂ in the air, or blowing O₂ into the cathode electrolytic solution using an air supply system.

In some embodiments of the present application, a resistor 6 is provided at the wire connecting the anode to the cathode, a digital multimeter 12 is connected in parallel at the resistor 6, and the digital multimeter 12 is connected to a computer 13.

An acid mine drainage fuel cell (AMD-FC) simultaneous electricity generation system has been divided into 7 subsystems: a fuel supply system, an iron ion oxidation system, an electron transmission system, a proton transfer system, an air supply system, an oxygen reduction reaction system, and a data acquisition system. A cell structure thereof mainly is composed of an anode chamber, a cathode chamber, an anode electrode, a cathode electrode, a proton exchange membrane, and an external wire. The proton exchange membrane is provided between the cathode chamber and the anode chamber. An anode is provided at one end of the anode chamber away from the cathode chamber, and a cathode is provided at one end of the cathode chamber away from the anode chamber. The anode is connected to the cathode by the wire outside the anode chamber and the cathode chamber. The anode chamber is isolated from oxygen and contains acid mine drainage. The cathode chamber contains oxygen.

In FIG. 1, reference numerals 7, 8, and 9 constitute a fuel supply system; reference numerals 1 and 3 constitute an iron ion oxidation system; reference numerals 1, 6, and 2 constitute an electron transmission system; reference numerals 3, 4, and 5 constitute a proton transfer system; reference numeral 11 constitutes an air supply system; reference numerals 2 and 4 constitute an oxygen reduction reaction system; and reference numerals 12 and 13 constitute a data acquisition system.

Total reaction: Fe²⁺+¼O₂+H⁺=Fe³⁺+½H₂O.

Anode: Fe²⁺→Fe³⁺+e⁻.

Cathode: O2+H++e−→H2O.

The anode chamber contains ferrous sulfate, and divalent iron is oxidized to trivalent iron, releasing electrons and forming a precipitate to remove iron from the drainage. In the cathode chamber, protons react with oxygen to generate water and consume electrons. Protons travel from the anode chamber to the cathode chamber through the proton exchange membrane, and most electrons generated in the anode chamber pass through the anode via the external circuit to the cathode to participate in the reaction, thereby forming the current.

A fuel cell reactor is composed of two organic glass chambers, each with a volume of 80 cm³, separated by a proton exchange membrane (Nafion® 117) in the middle. The anode is the carbon cloth (hydrophilic), the cathode is the carbon cloth loading Pt (0.5 mg/L), and the electrode area and proton exchange membrane area are 20.25 cm². The proton exchange membrane is sandwiched between two chambers with rubber rings to prevent leakage, and the anode electrode is located at the end of one chamber, covered with an organic plastic end plate. The cathode electrode is placed at one end of the other chamber and covered with the other end plate with a central hole. One side of Pt catalyst faces solution and the other side faces air. A 1 mm diameter platinum wire is used to connect two electrodes as terminals of the cell.

An acid mine drainage fuel cell simultaneous electricity generation method, where it is completed using the system above, and includes the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

TABLE 1
AMD Output Power at Different pH

| | | Pₘₐₓ |
|---|---|---|
| pH | OCV (mV) | (mW/m²) |
| 2 | 270 | 7.815 |
| 3 | 284 | 10.321 |
| 4 | 381 | 21.612 |
| 5 | 444 | 107.251 |
| 6 | 641 | 270.321 |

Table 1 shows the maximum power density generated by AMD under different pH conditions. The cell output power and open circuit voltage (OCV) increase with the increase of pH. When pH is 6, the open circuit voltage is 641 m V, and the maximum power density reaches 270.321 mW/m². Therefore, it can be seen that the higher the pH of acid mine drainage, the better the electricity generation effect.

TABLE 2
Removal Rate of Fe Ions in Acid Mine
Drainage of Anode Chamber

| Initial Fe²⁺ | 392 mg/L | |
|---|---|---|
| concentration | Fe²⁺ | Fe³⁺ |
| Concentration after | 2.244 | 2.322 |
| reaction (mg/L) | | |
| Removal rate | 99.4% | 99.4% |

Table 2 shows the removal rate of Fe ions in the acid mine drainage of the anode chamber. After the reaction is completed, the concentration of Fe ions in the acid mine drainage of the anode chamber is tested, and it is found that the concentration of Fe²⁺ is 2.244 mg/L, the concentration of Fe³⁺ ions is 2.322 mg/L, and the removal rate of Fe ions reaches 99%, indicating that Fe²⁺ is completely oxidized to Fe³⁺ to form a precipitate and is removed.

TABLE 3
pH Change of Two Electrode Chambers

| | Initial pH | pH after reaction | Precipitate |
|---|---|---|---|
| Anode | 6 | 4.32 | Have |
| Cathode | 6 | 7.74 | Not have |

The pH of the anode chamber and the cathode chamber before and after the reaction is detected, and it is found that the pH of the solution in the anode chamber decreases from 6 to 4.32. The main reason is that Fe²⁺ loses electrons and is converted into Fe³⁺, which combines with OH⁻ to form a precipitate, and the generated H⁺ decreases the pH of the anode chamber. The pH of the cathode chamber increases from 6 to 7.74. Since H⁺ ions in the cathode chamber participate in the reaction, the transmission rate of H⁺ from the anode chamber to the cathode chamber is lower than the consumption rate in the cathode chamber, increasing the pH of the cathode chamber. Therefore, the acid drainage after the anodic reaction is filtered as the cathode electrolytic solution for starting the reactor next time, achieving an increase of the pH.

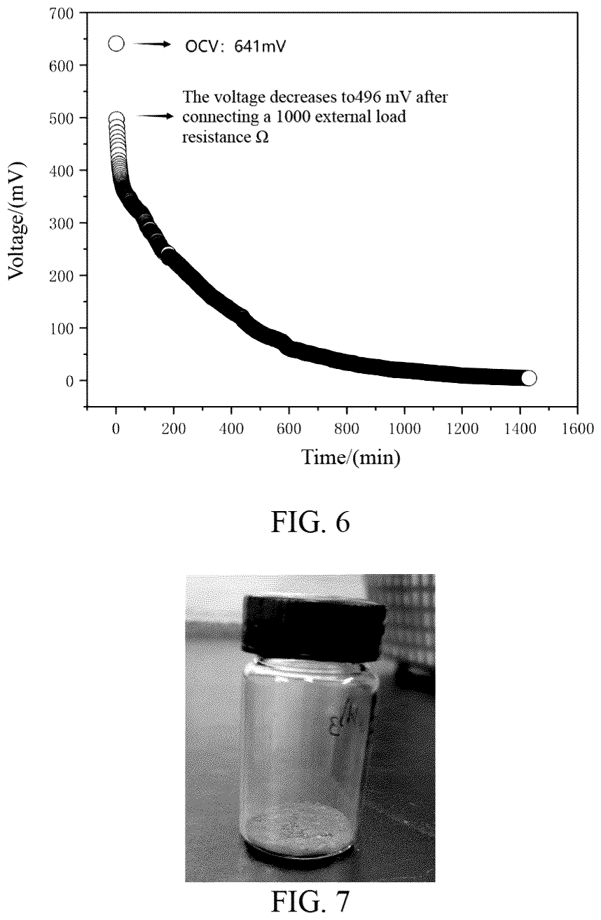

FIG. 6 is a voltage variation curve diagram using Fe²⁺ in AMD for electricity generation according to the embodiments of the present application. It can be seen from the figure that Fe²⁺ ions in AMD are used for the electricity generation, and the open circuit voltage is 641 mV. After connecting a 1000Ω external load resistor, the voltage immediately decreases to 496 mV, and then gradually decreases to 0 m V within the next 24 hours, mainly due to the gradual oxidation of Fe²⁺ ions.

FIG. 7 is a diagram of precipitates collected in an anode chamber, and it can be seen that the color of precipitates generated in the anode chamber is mainly yellow brown.

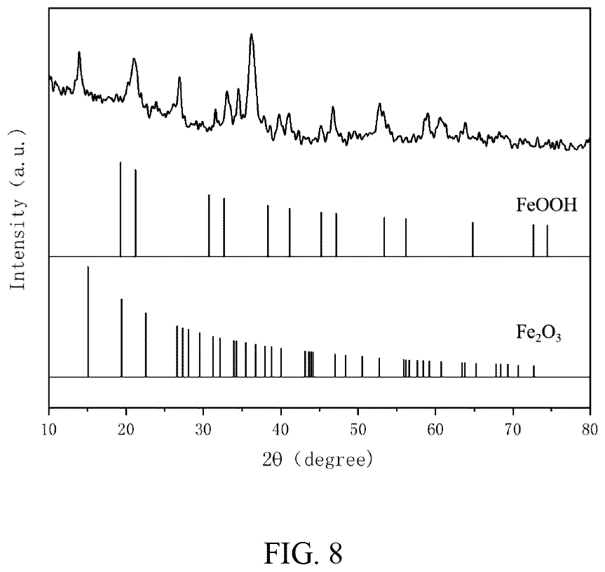

FIG. 8 is an X-ray diffraction pattern acquired by characterizing anode precipitates. Compared with the standard pattern, it can be seen that the main component in the sediment is FeOOH, and the generated goethite (FeOOH) can be used for iron-smelting or recycling as pigments.

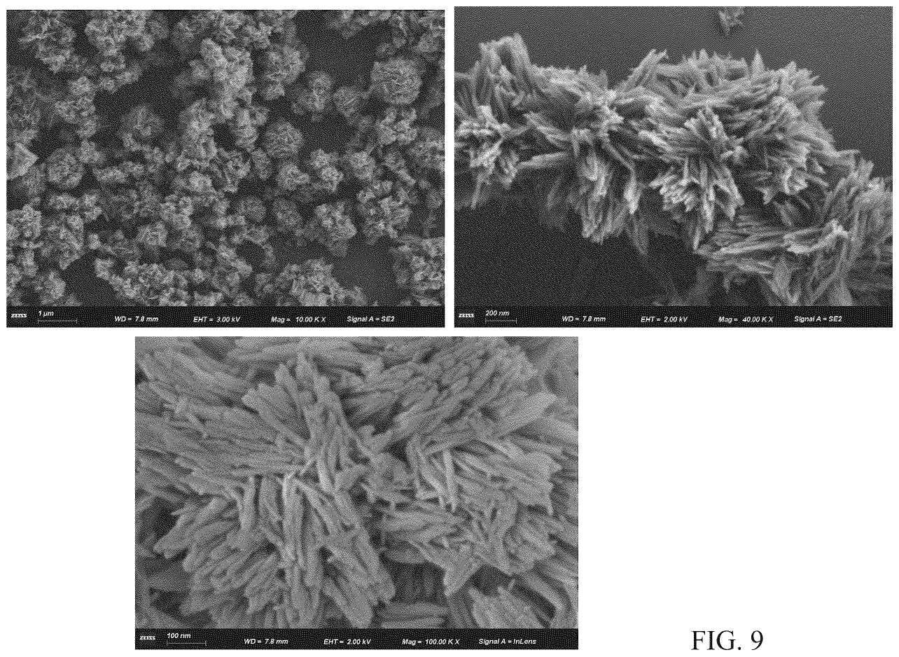

FIG. 9 is a SEM pattern acquired by characterizing anode precipitates, whose crystal shape is mainly needle shaped.

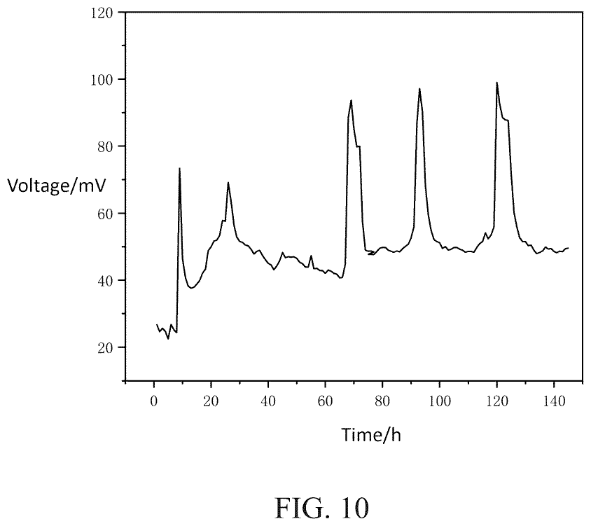

FIG. 10 is a continuous operation voltage curve diagram of AMD-FC. A peristaltic pump is used to continuously inject acid mine drainage into an anode chamber, and fresh water samples are added to an inlet sink occasionally. When a cell starts operating, the output voltage is low with small fluctuations. When the first batch of samples is added, the voltage increases to around 70 mV, and then decreases to around 40 m V. After the second batch of samples is added, the voltage once again increases to around 70 m V, and then decreases to around 45 m V for stable operation. Afterwards, for each batch of samples is added, the voltage increases to around 90 mV, and then decreases to around 50 mV for stable operation.

It should be noted that the above embodiments can be freely combined with each other as needed. Described above are the embodiments of the present application and are not intended to limit the present application. For those skilled in the art, the present application may have various modifications and changes. Any modifications, equivalents, improvements, and the like, made within the spirit and principle of the present application should fall within the protection scope of the present application.

### INDUSTRIAL APPLICABILITY

The present application provides an acid mine drainage fuel cell (AMD-FC) simultaneous electricity generation system and a method, where an anode chamber contains acid mine drainage and divalent iron in AMD is oxidized to trivalent iron, releasing electrons and forming a precipitate to remove iron from the drainage. In the cathode chamber, protons react with oxygen to generate water and consume electrons. Protons travel from the anode chamber to the cathode chamber through the proton exchange membrane, and most electrons generated in the anode chamber pass through the anode via the external circuit to the cathode to participate in the reaction, thereby forming the current. The solution of the present application is green and free from secondary pollution, achieving the resource utilization of acid mine drainage. The precipitate generated in the anode chamber can be used as the pigment to achieve iron ion recovery. The solution can also be used for the simultaneous electricity generation when treating the acid mine drainage containing iron. The formed products can be mass-produced and used in industry.

1: An acid mine drainage fuel cell simultaneous electricity generation system, comprising a cell structure, wherein the cell structure is composed of an anode chamber, a cathode chamber, an anode electrode, a cathode electrode, a proton exchange membrane, and an external wire; the proton exchange membrane is provided between the cathode chamber and the anode chamber; an anode is provided at one end of the anode chamber away from the cathode chamber, and a cathode is provided at one end of the cathode chamber away from the anode chamber; the anode is connected to the cathode by the wire outside the anode chamber and the cathode chamber; the anode chamber contains anode electrolytic solution, and the anode electrolytic solution contains ferrous sulfate; the cathode chamber contains cathode electrolytic solution; the anode chamber is provided with an anode outlet and an anode inlet; the anode inlet is connected to an anode inlet sink, and the anode inlet sink contains acid mine drainage that removes dissolved oxygen; the anode outlet is connected to an anode outlet sink; the cathode chamber is provided with a cathode inlet and a cathode outlet, the cathode inlet and the cathode outlet are connected to a cathode electrolytic solution supply apparatus, and the cathode chamber is further provided with an oxygen vent.

2: The acid mine drainage fuel cell simultaneous electricity generation system according to claim 1, wherein the cell structure is a dual chamber air fuel cell system, a single chamber air cathode fuel cell, an H-type dual chamber fuel cell, an upflow fuel cell, or a cylindrical fuel cell.

3: The acid mine drainage fuel cell simultaneous electricity generation system according to claim 1, wherein the anode chamber contains the anode electrolytic solution, and the anode electrolytic solution is the acid mine drainage: [Mn²⁺]=0-30 mg/L, [Fe²⁺]=100-2000 mg/L, [Zn²⁺]=0-80 mg/L, [SO₄²⁻]=300-2000 mg/L, [Na⁺]=3.22-6.9 g/L, [HCO₃⁻]=2.44-6.1 g/L, [Cl⁻]=3.55-7.1 g/L, pH=2-6; and the cathode chamber contains the cathode electrolytic solution: [Na⁺]=3.22-6.9 g/L, [HCO₃⁻]=2.44-6.1 g/L, [Cl⁻]=3.55-7.1 g/L, and H₂SO₄ for pH adjustment.

4: The acid mine drainage fuel cell simultaneous electricity generation system according to claim 1, wherein the acid mine drainage is continuously inputted into the anode chamber, and the acid mine drainage fuel cell simultaneous electricity generation system can continuously and stably operate.

5: The acid mine drainage fuel cell simultaneous electricity generation system according to claim 3, wherein the anode inlet of the anode chamber is connected to the anode inlet sink, and the anode inlet sink contains the acid mine drainage; the anode inlet sink is connected to an air bottle, and the air bottle is configured for accommodating CO₂ or N₂ to remove dissolved oxygen in the drainage; and the cathode inlet of the cathode chamber and the cathode outlet of the cathode chamber are respectively connected to the cathode electrolytic solution supply apparatus.

6: The acid mine drainage fuel cell simultaneous electricity generation system according to claim 4, wherein the anode outlet of the anode chamber is connected to the anode outlet sink, the anode outlet sink filters the reacted acid mine drainage as cathode electrolytic solution for starting a reactor next time, the pH of the acid mine drainage is increased in the cathode chamber, and new acid mine drainage is injected into the anode to remove Fe ions.

7: The acid mine drainage fuel cell simultaneous electricity generation system according to claim 6, wherein the anode is a carbon cloth and the cathode is a carbon cloth loading Pt.

8: The acid mine drainage fuel cell simultaneous electricity generation system according to claim 6, wherein the cathode chamber can use an air cathode, one side of a cathode electrode loading platinum catalyst faces solution and the other side contacts with air, directly using O₂ in the air, or blowing O₂ into the cathode electrolytic solution using an air supply system.

9: The acid mine drainage fuel cell simultaneous electricity generation system according to claim 6, wherein a resistor is provided at the wire connecting the anode to the cathode, a digital multimeter is connected in parallel at the resistor, and the digital multimeter is connected to a computer.

10: An acid mine drainage fuel cell simultaneous electricity generation system, wherein it is completed using the system according to claim 1, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

11: An acid mine drainage fuel cell simultaneous electricity generation system, wherein it is completed using the system according to claim 2, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

12: An acid mine drainage fuel cell simultaneous electricity generation system, wherein it is completed using the system according to claim 3, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

13: An acid mine drainage fuel cell simultaneous electricity generation system, wherein it is completed using the system according to claim 4, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

14: An acid mine drainage fuel cell simultaneous electricity generation system, wherein it is completed using the system according to claim 5, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

15: An acid mine drainage fuel cell simultaneous electricity generation system, wherein it is completed using the system according to claim 6, and comprises the following steps:
preparing electrolytic solution, anode electrolytic solution: acid mine drainage:
[Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

16: An acid mine drainage fuel cell simultaneous electricity generation system, wherein it is completed using the system according to claim 7, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

17: An acid mine drainage fuel cell simultaneous electricity generation system, wherein it is completed using the system according to claim 8, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.

18: An acid mine drainage fuel cell simultaneous electricity generation system, wherein it is completed using the system according to claim 9, and comprises the following steps:
preparing electrolytic solution, anode electrolytic solution: acid mine drainage: [Mn²⁺]=24.6 mg/L, [Fe²⁺]=492 mg/L, [Zn²⁺]=35.8 mg/L, [SO₄²⁻]=950 mg/L, [Na⁺]=5.06 g/L, [HCO₃⁻]=4.27 g/L, [Cl⁻]=5.325 g/L, H₂SO₄ for pH adjustment to 5; and cathode electrolytic solution: [Na⁺]=5.06 g/L, [HCO₃⁻]=4.27 g/L, [Cl⁻]=5.325 g/L, H₂SO₄ for pH adjustment to 5;
intermittent reaction:
continuously blowing CO₂ into acid mine drainage to remove dissolved oxygen in the drainage, using a peristaltic pump to transport the acid mine drainage to an anode chamber, and injecting the cathode electrolytic solution into the cathode chamber;
recording the voltage using a digital multimeter, and measuring the Fe ion removal rate of anode solution and the pH value of two electrode chambers when the voltage decreases to 0; and
filtering the above reacted acid mine drainage as the cathode electrolytic solution for starting a reactor next time, increasing the pH of the cathode chamber, and injecting new acid mine drainage into the anode chamber to remove Fe ions;
or
continuous reaction:
injecting acid mine drainage into a sink and continuously blowing CO₂ to remove dissolved oxygen in the drainage, use a peristaltic pump to transport the acid mine drainage to an anode chamber, with a flow rate of 0.2 mL/min and hydraulic retention time of 6 hours, and using a digital voltmeter to continuously record the voltage and detect the pH and Fe ion concentration of effluent drainage of the anode.
